(19) United States
(12) Patent Application Publication
(10) Pub. No.: US 2008/0307338 A1
(43) Pub. Date: Dec. 11, 2008

(54) Interface representing cookbook for facilitating charitable giving to charity

(76) Inventor: Edward A. Maurer, Leesburg, VA (US)

Correspondence Address: Edward A. Maurer, 17144 Clarksridge Road, Leesburg, VA, 20176, US

(21) Appl. No.: 11/808,373

(22) Filed: Jun. 8, 2007

(51) Int. Cl. G06F 3/048

(52) U.S. Cl. 715/764; 715/810

(57) ABSTRACT

A method (e.g., provided in the form of a machine-readable medium on which are recorded machine-executable instructions for performing the method, execution of which by a machine provides an interface representing a cookbook for facilitating charitable giving to a charity) includes: providing at least one of first, second and third recipes for accomplishing (1) a first mission of making at least one of a postal-based, an email-based and a telephone-based appeal for donations, respectively, (2) a second mission of dealing with donations received, and (3) a third mission of acknowledging receipt of donations, respectively, each recipe including names of tasks, performance of which cumulatively accomplishes the corresponding mission, and a given recipe being provided without also providing application software by which to carry out the respective tasks; and automatically generating an interface by which an agent of the charity can at least view the respective recipes.

### BACKGROUND

Charitable fundraising is a service industry. There are at least a few characteristics of charitable fundraising that set it apart from other service industries. Charitable institutions that raise funds by being the recipients of charitable giving are either non-profit organizations or not-for-profit organizations. Ironically, charitable institutions seek to amass wealth.

Participants in the charitable fundraising industry include institutions having sophisticated fundraising infrastructure and operating on a large scale. The typical participant in the charitable fundraising industry, however, neither operates on a large scale nor uses sophisticated fundraising infrastructure.

The large scale participants represent relatively few of the total number of participants in the charitable fundraising industry. On a per-participant basis, however, the amount of the funds raised by a typical large scale participant is substantially greater than the amount of funds raised by the typical participant.

Large scale participants typically use commercially available, expensive, charitable fundraising-specific software.

### SUMMARY

An embodiment of the present invention provides a machine-readable medium comprising machine-executable instructions for performing a method, execution of which by a machine provides an interface representing a cookbook for facilitating charitable giving to a charity. Such a method can include: providing at least one of first, second and third recipes for accomplishing (1) a first mission of making at least one of a postal-based, an email-based and a telephone-based appeal for donations, respectively, (2) a second mission of dealing with donations received, and (3) a third mission of acknowledging receipt of donations, respectively, each recipe including names of tasks, performance of which cumulatively accomplishes the corresponding mission, and a given recipe being provided without also providing application software by which to carry out the respective tasks; and automatically generating an interface by which an agent of the charity can at least view the respective recipes. Another embodiment of the present invention provides a corresponding method. Another embodiment of the present invention provides a corresponding apparatus.

An embodiment of the present invention provides a machine-readable medium comprising machine-executable instructions for performing a method, execution of which by a machine facilitates charitable giving to a charity, the method including: providing a donor database; receiving a first data file including data indicative of charitable payments received on behalf of the charity, the amounts thereof, and identifications of the payors thereof, respectively; automatically updating the donor database according to the first data file; and automatically generating, based upon the updated donor database, a second data file representing a list donors to whom a gift acknowledgement should be communicated. Another embodiment of the present invention provides a corresponding method. Another embodiment of the present invention provides a corresponding apparatus.

Additional features and advantages of the present invention will be more fully apparent from the following detailed description of example embodiments, the accompanying drawings and the associated claims.

### BRIEF DESCRIPTION OF THE DRAWINGS

FIG. 1 depicts an block diagram of a system architecture 200 according to an example embodiment of the present invention.

FIG. 2 is a block diagram (according to an example embodiment of the present invention) of a typical arrangement of components in PC.

FIGS. 3A-3B are diagrams (according to at least one example embodiment of the present invention) that combine task-flow and data-flow to provide a context in which to appreciate tasks named in recipes of a charitable-fundraising cookbook.

FIG. 4 is a UML-type sequence diagram depicting (according to an example embodiment of the present invention) actions/steps in a method of providing an interface representing an interactive cookbook for facilitating charitable giving to a charity.

FIG. 5 is a UML-type sequence diagram depicting in more detail (according to an example embodiment of the present invention) actions/steps in a portion of FIG. 4.

FIG. 6 is a UML-type sequence diagram depicting in more detail (according to an example embodiment of the present invention) actions/steps in a portion of FIG. 4.

FIG. 7 is a UML-type sequence diagram depicting (according to an example embodiment of the present invention) actions/steps in a method of facilitating charitable giving to a charity.

Actions in a UML-type sequence diagram are depicted with arrows of different styles. A solid-head arrow → indicates a synchronous action for which the sender awaits a response action. A solid, open-head arrow → indicates an asynchronous action for which the sender may expect, but does not await, a response or expects no response at all.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

It will be understood that if an element or layer is referred to as being “on,” “against,” “connected to” or “coupled to” another element or layer, then it can be directly on, against connected or coupled to the other element or layer, or intervening elements or layers may be present. In contrast, if an element is referred to as being “directly on”, “directly connected to” or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In developing one or more embodiments of the present invention, the inventor recognized at least the following: a large segment of the participants in the charitable fundraising industry are small scale institutions, for example, local church communities (e.g., parishes as contrasted with a diocese), local school groups, local volunteer firefighters, local volunteer service organizations, local athletic organizations, etc., whose charitable fundraising is not guided/mentored/controlled by a parent organization; on a per-participant basis, the amount of the funds raised by a typical large scale participant dwarfs the amount of funds raised by the typical small scale participant; the number of small scale participants, however, dwarfs the number of large scale participants; and, at least because of its large cost, the commercially available, expensive fundraising-specific application software ignores the large segment of small scale participants in the charitable fundraising industry.

In developing one or more embodiments of the present invention, the inventor also recognized at least the following: if guided/mentored as to charitable fundraising tasks and/or infrastructure, the typical small scale participant can increase significantly the amount of charitable funds it raises using the same (if not fewer) staff members and using non-charitable-fundraising-specific software (e.g., a database, a word processor, an email interface, etc.) available on a typical small office computer, i.e., without having to commit financial resources to substantially enlarging its staff and/or purchasing commercially available, expensive fundraising-specific application software.

At least one embodiment of the present invention provides software (a machine-readable medium comprising machine-executable instructions) that can be used to guide/mentor a charitable organization, e.g., a small scale participant in the charitable fundraising industry (as discussed above), wherein such software (when executed by a machine) can perform a method of providing an interface representing a cookbook for facilitating charitable giving to a charity. Such a method facilitates charitable giving to a charity by (at least): providing at least one of first, second and third recipes for accomplishing (1) a first mission of making at least one of a postal-based, an email-based and a telephone-based appeal for donations, respectively, (2) a second mission of dealing with donations received, and (3) a third mission of acknowledging receipt of donations, respectively, each recipe including names of tasks, performance of which cumulatively accomplishes the corresponding mission, and a given recipe being provided without also providing application software by which to carry out the respective tasks; and automatically generating an interface by which an agent of the charity can at least view the respective recipes.

Here, interactive guidance/mentoring of a charitable organization is being analogized to the guidance/mentoring that a chef receives when making use of a conventional cookbook in order, e.g., to bake a cake. More particularly, the cake can be analogized to a mission, e.g., (1) making at least one of a postal-based, an email-based and a telephone-based appeal for donations, respectively, (2) dealing with donations received, (3) acknowledging receipt of donations, respectively; etc. Just as conventionally there are recipes for baking the cake, here (by analogy) there are recipes for carrying out the missions. Missions include tasks. Just as a conventional recipe for the cake might include ingredients such as flour, sugar, butter, eggs, salt, etc., here (by analogy) a recipe includes names of tasks. Hence, an interactive interface by which such guidance/mentoring of the charitable organization is communicated to a user can be described as an interactive cookbook.

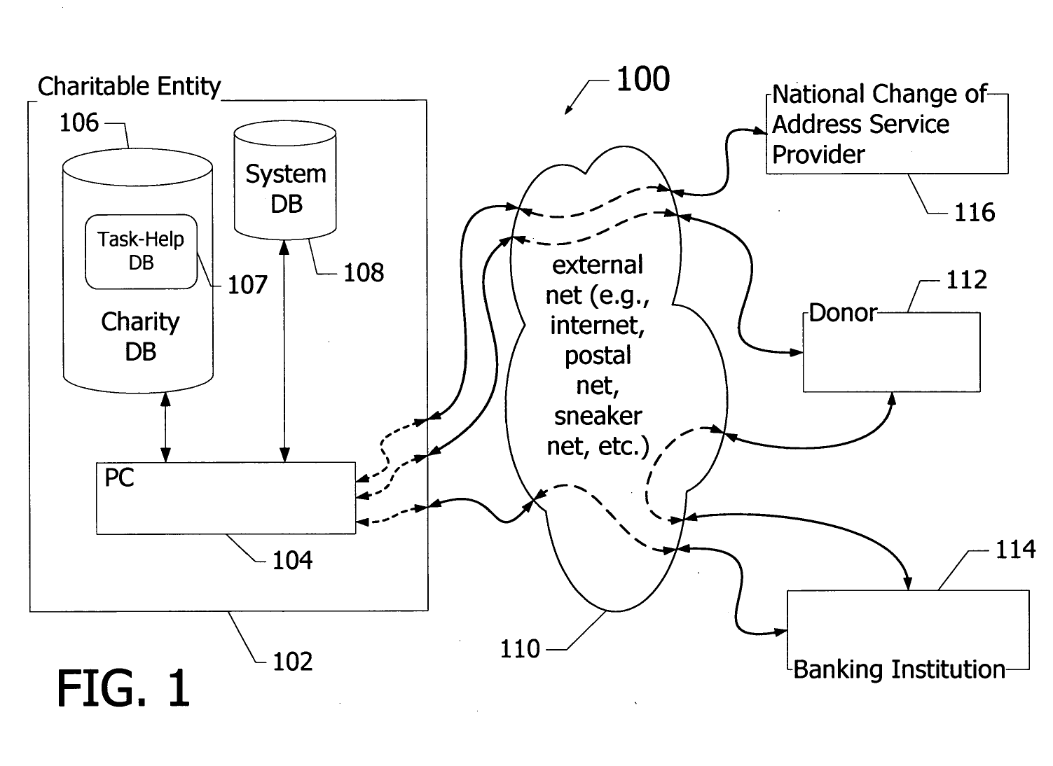

FIG. 1 depicts an block diagram of a system architecture 200 according to an example embodiment of the present invention.

In FIG. 1, architecture 200 includes a charitable organization/entity (or, in other words, donee) 102, which can communicate via an external communication network 110 with a donor (be it of an established type or a prospective type) 112, a banking institution 114 and optionally with a National Change of Address Service Provider 116. Entity 102 includes a personal computer (“PC”) 104, a charity database (“DB”) 106 and a system DB 108. Charity DB 107 itself can include a task-help database (again, “DB”) 107. External network 110 can include the internet, one or more circuit switched telephone networks, one or more public postal networks, one or more private courier networks, one or more informal personal communication/exchange (“sneaker”) networks, etc.

A given communication passing through network 110 can use one or more of the various networks included within network 110. According, as a communication path crosses network 110, it is depicted with a dashed line. Correspondingly, a communication path to/from entity 102 is depicted as extending inside entity 102 to PC 104 using a dashed line to call attention to at least some, but not necessarily, all communications by entity 102 being made via PC 104. For example, a communication to a donor 112 from entity 102 may be made by a human staff member of entity 102 solely via a telephone (not depicted), or via an in-person (face-to-face) exchange (not depicted), or a combination of both. A depiction of the communication path corresponding to such a telephonic communication would include network 110 but not necessarily include PC 104 unless, e.g., entity 102 uses a non-circuit-switched telephony system such as voice-over-internet-protocol (“VOIP”) telephony.

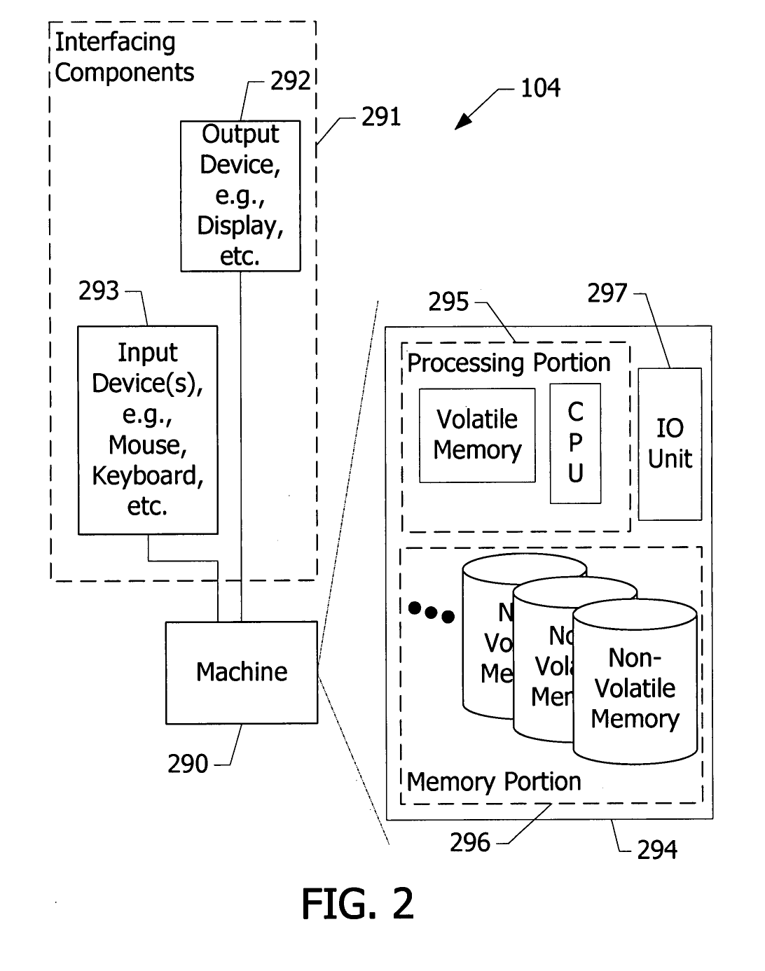

FIG. 2 is a block diagram (according to an example embodiment of the present invention) of a typical arrangement of components in PC 102.

In FIG. 2, the typical arrangement of components in PC 102 includes a machine 290, an output device 292, e.g., a display device, and input devices, e.g., a mouse, keyboard, etc. Typical contents of machine 290 are indicated in the exploded view 294. Such contents can include: a processing portion 295; a memory portion 296; and an input/output (IO) unit 297. Processing portion 295 can include a central processing unit (CPU), volatile memory (e.g., RAM, etc.), etc. Memory portion 296 can include non-volatile memory (e.g., disk drives, etc.), etc. Among other things, PC 102 can generate a command line interface (“CLI”), a graphical user interface (“GUI”) driven by pointing-device-events. It is noted that DBs 106 and 108 are depicted as separate from PC 104 in FIG. 1. Typically (though not necessarily), electronic versions of DBs 106-108 are stored in memory portion 296.

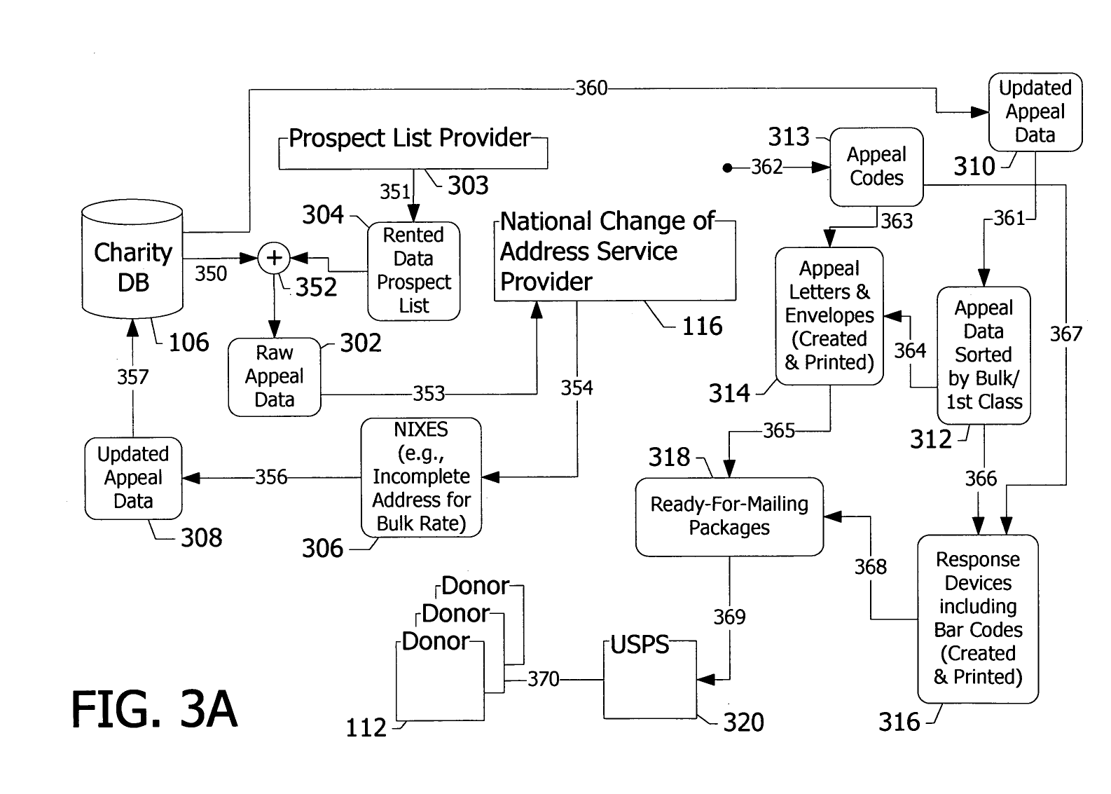

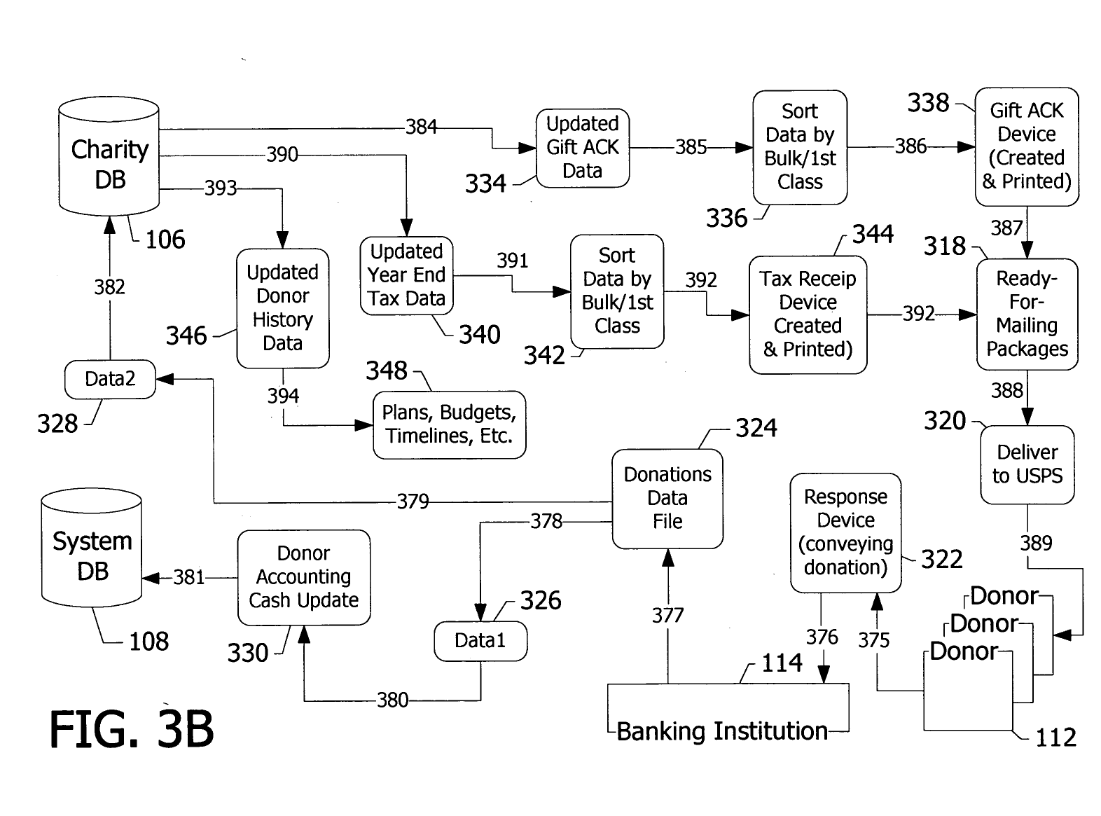

FIGS. 3A-3B are diagrams (according to at least one example embodiment of the present invention) that combine action flow (e.g., charitable-entity-specific task-flow) and data-flow to provide a context in which to appreciate tasks that can be named in recipes of a charitable-fundraising cookbook.

To illustrate an example context in which to better appreciate, e.g., tasks that can be named in recipes (again, e.g., for (1) making at least one of a postal-based, an email-based and a telephone-based appeal for donations, respectively, (2) dealing with donations received, (3) acknowledging receipt of donations, respectively, etc.) provided by an interface (generated by software, e.g., running on PC 104) representing a charitable-fundraising cookbook, FIGS. 3A-3B are provided.

Assuming a decision has been made to launch an appeal (by which donors and prospective donors are requested to make a donation), typical phases of making the appeal can include: an initial phase of updating the charity's appeal data; after the initial phase, a broaching phase, namely broaching the appeal message to the donor targets; after the broaching phase, a donation processing phase by which donors' donations are processed by the charitable entity; and after the donation processing phase (typically after completion thereof), a feedback phase in which feedback regarding the received donations is provided, e.g., in the form of gift acknowledgments sent to donors, etc.

In FIG. 3A, examples of tasks, actions and data in the initial phase can include: a task of outputting 350 data from charity DB 106; a task of obtaining 351 “rented” data 304 representing prospective donors from a prospect list provider entity 303; combining 352 the charity's data and rented data 304 to produce raw appeal data 302; providing 353 the raw appeal data to National Change of Address Service Provider (“NCOA”) 116; receiving 354 address-checked data 306, e.g., incomplete addresses insufficient for bulk mailing “nixes”, from NCOA 116; updating 356 raw appeal data 302 to obtain updated appeal data 308; and storing 357 updated appeal data 308 into charity DB 106.

Further in FIG. 3A, examples of tasks, actions and data in the broaching phase can include: outputting 360 updated appeal data 310 from charity DB 106; sorting 361 updated appeal data 310 (e.g., by bulk-mailing and first-class mailing categories) to form sorted appeal data 312; creating 362 appeal codes 313; making use 363 and 364 of appeal codes 313 and sorted appeal data 312, respectively, to create & print instances 314 of an appeal communication, e.g., printed letters & envelopes; and making use 366 and 367 of sorted appeal data 312 and appeal codes 313, respectively, to create & print instances 316 of a response device, e.g., donation card (optionally including a bar-code indicative of information such as the appeal codes, etc.) and printed envelope (optionally including a bar-code indicative of information such as the appeal codes, etc.);

Also included in the examples of tasks, actions and data in the broaching phase of FIG. 3A are: assembling 365 and 369 the printed documents (e.g., collating letters and response devices, stuffing envelopes, etc.) to obtain ready-to-be-mailed packages 318; depositing 369 packages 318 with a delivery service 320, e.g., the United States Postal Service (“USPS”); and making respective deliveries 370 of mailed packages to donors 112. In FIG. 3A, making deliveries 370 has been called out as a separate action. However, from the perspective of a typical instance of charitable entity 102, making deliveries 370 is subsumed in the task of depositing 369.

In FIG. 3A, (and, for that matter, FIG. 3B—discussed below), only three instances of donor 112 are depicted, for simplicity. It should be understood that a typical appeal would include a greater number of instances of donor 112. Alternatively, however, an appeal can include as few as one instance of donor 112.

In FIG. 3B, examples of tasks, actions and data in the donation-processing phase can include: sending 375 completed response devices 322 from donors 112 (from the perspective of a typical instance of charitable entity 102, sending 375 is an action, not a task thereof); receiving 376 completed response devices 322 (e.g., a bar-coded envelope addressed to banking institution 114, the envelope enclosing a donation card (itself optionally bar-coded) and a check drawn upon a given donor's checking account and payable to the charitable entity, etc.) at banking institution 114 with which the charitable entity has an account (from the perspective of a typical instance of charitable entity 102, receiving 376 is an action, not a task thereof); and banking institution 114 generating/outputting 377 a donations data file 324 (from the perspective of a typical instance of charitable entity 102, generating/output 377 is an action, not a task thereof.

Also included in the examples of tasks, actions and data in the donation-processing phase of FIG. 3B are: operating 378 upon donations data file 324 to produce a first data set 326 (Data1) for depository purposes; operating 379 upon donations data file 324 to produce a second data set 328 (Data2) for gift acknowledgement and/or donor history purposes; using 380 data set 326 (Data1) to produce updated donor-accounting cash data 330; storing 381 updated donor-accounting cash data 330 to system DB 328; and using 382 second data set 328 (Data2) to update gift acknowledgement data and/or donor history data in charity DB 106.

Further in FIG. 3B, examples of tasks, actions and data in the feedback phase can include: outputting 384 updated gift acknowledgement data 334 from charity DB 106; sorting 385 updated gift acknowledgement 334 (e.g., by bulk-mailing and first-class mailing categories) to form sorted gift acknowledgement data 336; making use 386 of sorted gift acknowledgement data 336 to create & print instances 338 of a gift acknowledgment device, e.g., printed letters & envelopes; assembling 387 the printed documents (e.g., stuffing envelopes, etc.) to obtain ready-to-be-mailed packages 318; depositing 369 packages 318 with a delivery service 320, e.g., the United States Postal Service C“USPS”); and making 370 respective deliveries of mailed packages to donors 112.

Additional examples of tasks, actions and data in the donation-processing phase of FIG. 3B can include: outputting 390 updated year end tax data 340 (regarding donors' donations, respectively, in a given tax year) from charity DB 106; sorting 391 updated year end tax data 340 (e.g., by bulk-mailing and first-class mailing categories) to form sorted tax data 342; making use 392 of sorted tax data 342 to create & print instances 344 of a tax receipt device, e.g., printed letters & envelopes; assembling 392 the printed documents (e.g., stuffing envelopes, etc.) to obtain ready-to-be-mailed packages 318; etc.

Further examples of tasks, actions and data in the donation-processing phase in FIG. 3B can include: outputting 393 updated donor history data 346 (e.g., regarding donors' historical given patterns, demographics, trends, etc.) from charity DB 106; and making use 394 of updated donor history data 346 to generate management data 348 (e.g., plans, budgets, timelines, etc.).

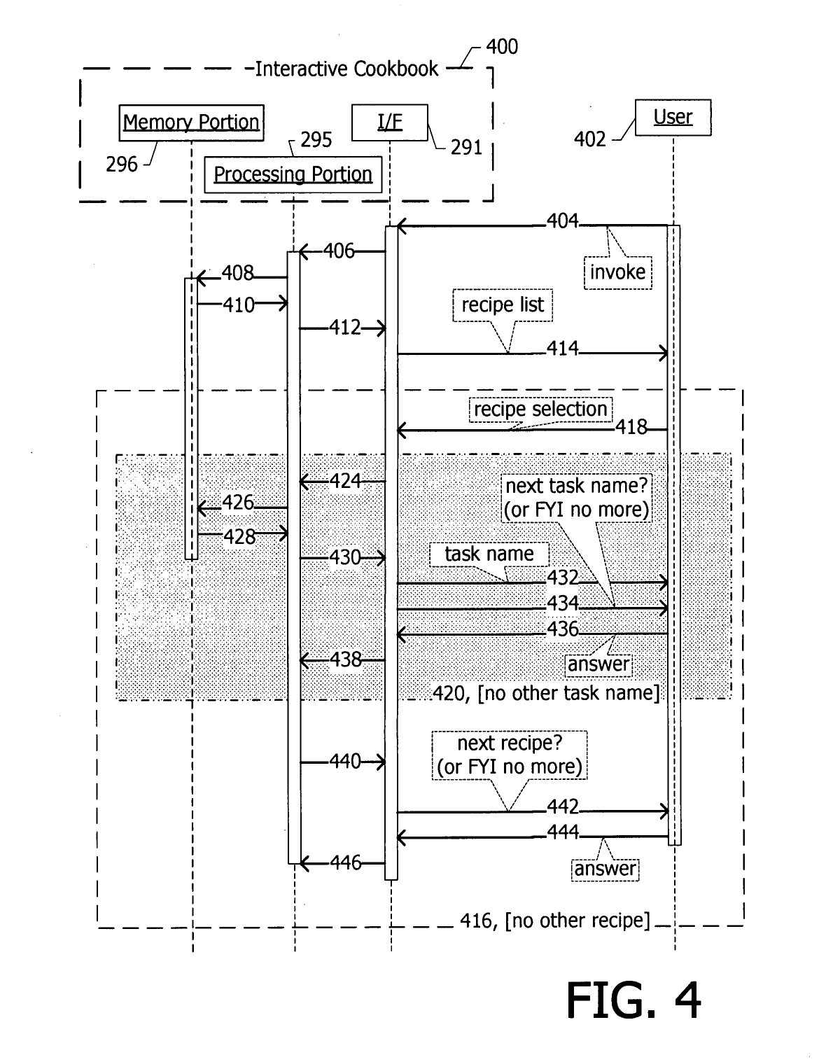

FIG. 4 is a UML-type sequence diagram depicting (according to an example embodiment of the present invention) actions/steps in a method of providing an interface representing an interactive cookbook for facilitating charitable giving to a charity.

In FIG. 4, a user 402 (e.g., an agent of charitable entity 102 such as an employee or a volunteer) and an interface representing an interactive cookbook 400 are depicted. Cookbook 400 can include: interface components (“I/F”) 291; processing portion 295; and memory portion 296. Assuming that user 402 wishes to be prompted with tasks for accomplishing a mission, then IF 291 receives 404 an invocation from user 402 for such guidance/mentoring. The invocation is relayed 406 to processor portion 295, which requests 408 memory portion 296 to provide program code appropriate for presenting user 402 with a list of recipes. In response, memory portion 296 provides 410 the requested program code. Processing portion 295 generates 412 signals by which I/F 291 presents 414 user 402 with a list of recipes (for accomplishing missions, respectively) from which to choose.

After action 414, flow proceeds into a loop 416, inside of which is nested a loop 420. In loop 416, user 402 interacts with cookbook 400 to review as many of the recipes as user 402 might desire. Hence, an exit condition for loop 416 is there being no other recipes which user 402 wishes to review. In loop 420, user 402 interacts with cookbook 400 to review as many of the names of tasks (ingredients), in a given recipe, as user 402 might desire. Hence, an exit condition for loop 420 is there being no other names of tasks which user 402 wishes to review.

Inside loop 416, IF 291 receives 418 an indication from user 402 of a selected recipe for accomplishing a corresponding mission. Moving inside loop 420, the request is relayed 424 to processor portion 295, which requests 426 memory portion 296 to provide program code appropriate for presenting user 402 with a first/next task name (and, optionally, additional descriptive data) for the selected recipe. In response, memory portion 296 provides 428 the requested task name. Processing portion 295 generates 430 signals by which I/F 291 presents 432 user 402 with current task name, etc.

Tasks corresponding to task-names in a recipe for the mission of making at least one of a postal-based, an email-based and a telephone-based appeal for donations, respectively, e.g., can include: defining as a first ingredient a charitable donation, in terms of characteristics thereof, that is being solicited; defining as a second ingredient a target group, in terms of characteristics thereof, to whom the solicitation is to be made; drafting a written statement, for which the intended reader is a member of the target group, describing that which is to be solicited; populating the target group with members; making a list of new members of the target group; vetting the list via an external resource; etc.

At arrow 434, based also upon signals generated 430 by processing portion 295, I/F 291 informs 434 user 402 that another (e.g., next) task name remains available or that no other task names remain in the selected recipe for review. I/F 291 receives 436 from user 402 either an indication of another selected task name or an indication that he is finished with his review of the selected task. The response is relayed 438 to processor portion 295

If the response (relayed at action 438) is a request for another task name, then flow loops back to action 424, etc. However, if the response (relayed at action 438) indicates that user 402 is finished with his review of the given task, then flow exits loop 420. Next, processing portion 295 generates 440 signals by which I/F 291 informs 442 user 402 that another (e.g., next) recipe remains available or that no other recipes remain which have not yet been reviewed (e.g., in a current review cycle). I/F 291 receives 444 from user 402 an indication of another selected recipe or an indication that he is finished with his review of recipes for the current review cycle. The response is relayed 446 to processor portion 295.

If the response (relayed at action 446) is a request for another recipe, then flow loops back into loop 420 at action 424, etc. However, if the response (relayed at action 446) indicates that user 402 is finished with his review of recipes for the current review cycle, then flow exits loop 416.

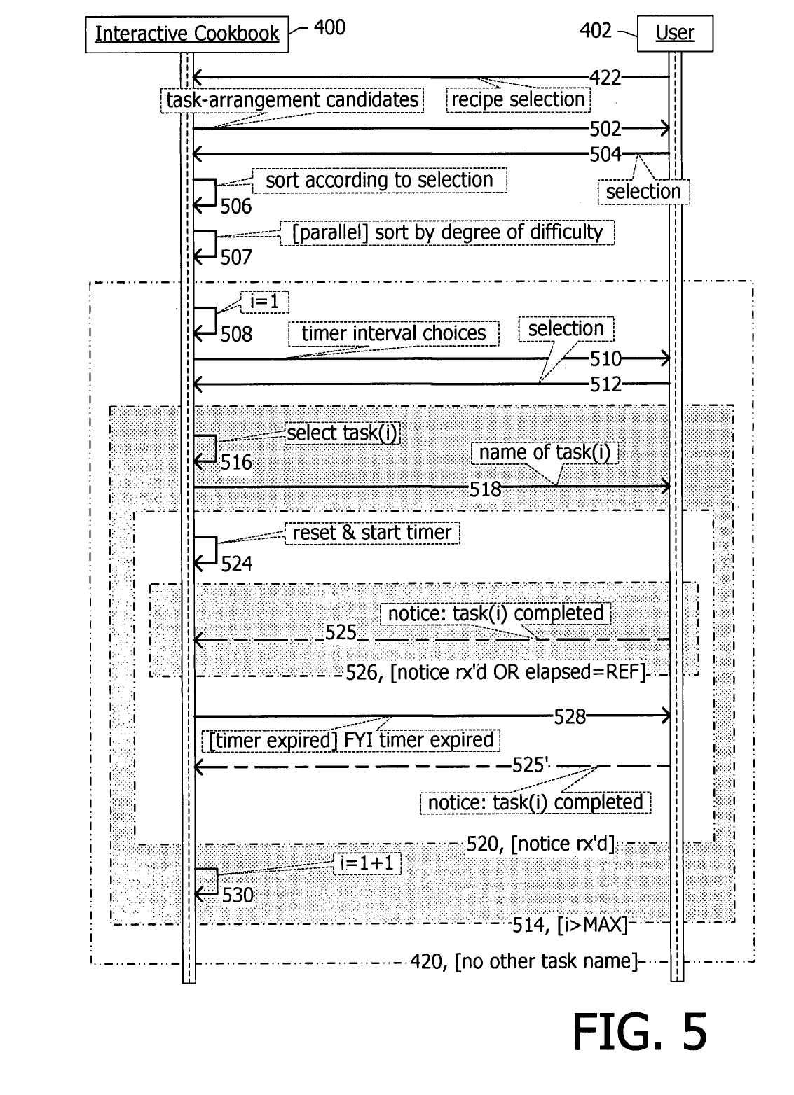

FIG. 5 is a UML-type sequence diagram depicting in more detail (according to an example embodiment of the present invention) actions/steps in a portion of FIG. 4.

For simplicity (e.g., vis-à-vis FIG. 4), FIG. 5 depicts interactive cookbook 400 without depicting those components that it can include (again, I/F 291; processing portion 295; and memory portion 296).

In FIG. 5, after user 402 requests 422 a given recipe (from the list) and before entering loop 420, the following can occur. Cookbook 400 can automatically prompt 502 user 402 with task-arrangement candidates. An example of a first arrangement would order the tasks as a single path of serial execution. Extending the first example, tasks that otherwise could be performed in parallel could be ordered according to a degree of difficulty. An example of a second arrangement would be a hybrid serial/parallel organization, where at least some of the sequence is a single path of serial execution and at least some of the sequence is represented by parallel paths of serial execution. Extending the second example, tasks that otherwise could be performed in parallel could be ordered according to a degree of difficulty. Cookbook 400 receives 504 a selection from user 402, sorts 506 according to the selection, and further sorts 507, if there are tasks that could be performed in parallel, according to a degree of task-difficulty amongst the parallel tasks. Action 507 is conditional upon the existence of parallel tasks, hence the condition is indicated in the label via square brackets, namely “[parallel]”.

After action 507 in FIG. 5, flow proceeds inside loop 420 to action 508, wherein cookbook 400 initializes a counting variable, i, e.g., i=1. Then cookbook 400 prompts 510 user 402 with choices for reminder intervals. At arrow 512, cookbook 400 receives an indication of the selected interval from user 502.

After action 512 in FIG. 5, flow proceeds inside loop 514 to action 516, wherein cookbook 400 treats the selected recipe as a set and at least the task-names in the selected recipe as members of the set, and selects task(i) from recipe. At arrow 518, cookbook 400 automatically provides the name of task(i) to user 402, which impliedly prompts user 402 to complete task(i). Alternatively, cookbook 400 may explicitly prompt user 402 to complete task(i).

After action 518 in FIG. 5, flow proceeds inside loop 520 to action 524, wherein cookbook 524 resets and starts a timer (not depicted). After action 524, flow proceeds inside loop 526. The exit condition of loop 526 is the elapsed time counter by the timer reaching a reference value (REF) or receipt of a notice that task(i) has been completed. While waiting in loop 526, cookbook 400 might receive 525 from user 402 a notice that task(i) has been completed. To emphasize that the notice may or may not be received in loop 526, arrow 525 is depicted as a dashed arrow formed of long and short dashes. Instead of being received from user 402, it is noted that the notice could be received from a service provider (e.g., banking institution 114, delivery service 320, NCOA (again, National Change of Address Service Provider) 116, etc.) with whom charity entity 102 has an arrangement to service task(i).

Upon leaving loop 526, if the timer has expired, cookbook 400 prompts 528 user 402 with a warning that the reference amount of time has elapsed while awaiting complete of task(i). If loop 526 was exited due to having received the notice, then action 528 is skipped. Action 528 is conditional upon the timer having expired, hence the condition is indicated in the label via square brackets, namely “[timer expired]”.

The exit condition of loop 520 is receipt by cookbook 400 of the notice regarding task(i) has been completed. As the notice might be received after having sent the warning at action 528, an arrow 525′ is depicted inside loop 520 after action 528. To emphasize that the notice may or may not be received outside loop 526 albeit inside loop 520, arrow 525′ is depicted as a dashed arrow formed of long and short dashes.

Upon leaving loop 526, cookbook 400 increments 530 the counter, e.g., i=i+1. The exit condition of loop 514 is the count value (i) exceeding the maximum value, MAX. If the count value (i) is less than or equal to MAX, i.e., i≦MAX, then flow loops by returning to action 514, etc.

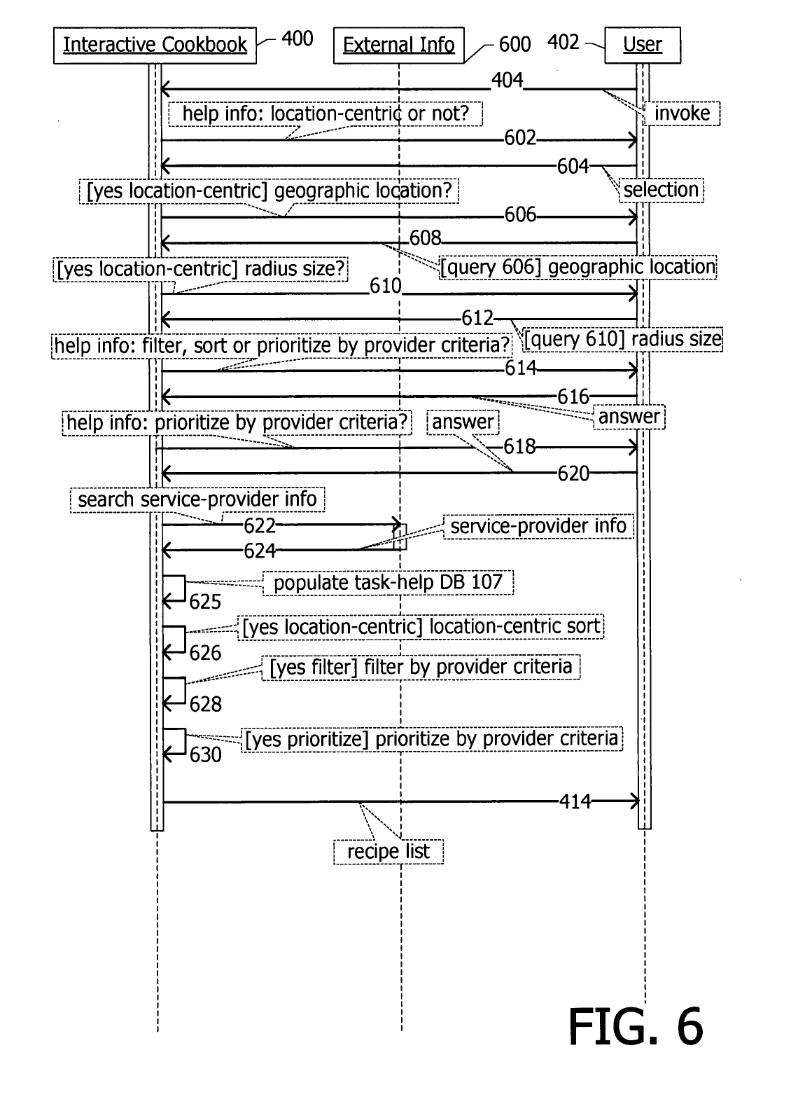

FIG. 6 is a UML-type sequence diagram depicting in more detail (according to an example embodiment of the present invention) actions/steps in a portion of FIG. 4.

As noted, charity DB 107 can include a task-help database (again, “DB”) 107. Cookbook 400 can use task-help DB 107 to provide user 402 with help regarding at least some of the task-names. For example, such help can be in the form of information explaining, for a given task-name, at least one of what the corresponding task is and a suggestion as to how the corresponding task can be performed, and/or contact information for one or more service provider candidates appropriate to a given task name, etc.

In FIG. 6, after cookbook 400 receives 404 an invocation from user 402 for guidance/mentoring, and before cookbook 400 presents 414 user 402 with a list of recipes from which to choose, the following can occur. To facilitate providing help information better suited to the preferences of user 402, cookbook 402 can automatically prompt 602 user 402 for a selection between prospective help information that is, or is not, charity-location-centric (or, in other words, has been filtered, sorted, and/or prioritized, etc., relative to the geographical location of charitable entity 102). At arrow 604, cookbook 400 receives data indicative of the selection by user 402.

If the selection received 604 from user 402 is for location-centric help, then cookbook 400 automatically prompts 606 user 402 for a geographical location to be designated. Action 606 is conditional, which is indicated by the square brackets in the label, namely “[yes location-centric]”. At arrow 608, cookbook 400 receives from user 402 data indicative of a geographical location of charitable entity 102. Action 608 is conditional upon action 606 taking place, which is indicated by the square brackets in the label, namely “[query 606]”.

Also, if location-centric help has been selected, then cookbook 400 automatically prompts 610 user 402 to designate a reference radial distance relative to the geographical location of charitable entity 102 by which a information regarding a set of one or more service provider candidates appropriate to a given task name can be, e.g., filtered, sorted, and/or prioritized, etc. Action 610 is conditional, which is indicated by the square brackets in the label, namely “[yes location-centric]”. At arrow 612, cookbook 400 receives from user 402 data indicative of a geographical location of charitable entity 102. Action 612 is conditional upon action 610 taking place, which is indicated by the square brackets in the label, namely “[query 610]”.

Candidate service providers can be filtered, sorted and/or prioritized according to demographic and/or tax-status criteria, etc. Criteria to filter, sort and/or prioritize can include whether a given service provider has status as least one of the following: a minority-owned business; a charity; a non-profit entity; a not-for-profit entity; a faith-based organization; etc.

At arrow 614, cookbook 400 automatically provides user 402 with at least two candidate criteria from which to choose. At arrow 616, cookbook 400 receives from user 402 data indicative of a provider criterion. At arrow 618, cookbook 400 automatically prompts user 402 to designate whether the selected criterion is to be used to filter, sort or prioritize. At arrow 620, cookbook 400 receives from user 402 data indicative of the answer to the query of arrow 618.

At arrow 622, cookbook 400 queries one or more external resources to obtain information regarding candidate service providers. At arrow 624, cookbook 400 receives the requested candidate service provider information. At arrow 625, cookbook 400 populates task-help DB 107 with candidate service provide information.

At arrow 626, cookbook 400 performs a location-centric manipulation, e.g., sort, of the candidate service provider information in task-help DB 107. Action 626 is conditional, which is indicated by the square brackets in the label, namely “[yes location-centric]”. At arrow 628, cookbook 400 performs a provider-criteria-based manipulation, e.g., filtering, of the candidate service provider information in task-help DB 107. Action 628 is conditional, which is indicated by the square brackets in the label, namely “[yes filter]”. At arrow 630, cookbook 400 performs another provider-criteria-based manipulation, e.g., prioritization, of the candidate service provider information in task-help DB 107. Action 630 is conditional, which is indicated by the square brackets in the label, namely “[yes prioritize]”.

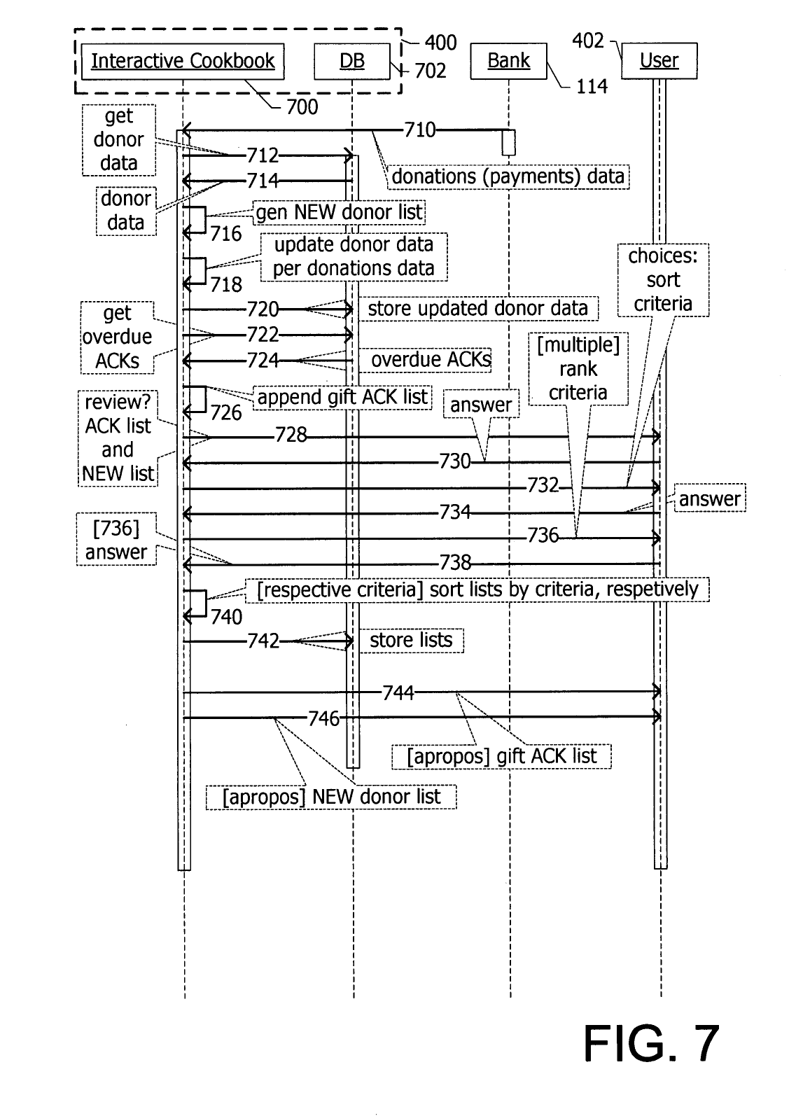

FIG. 7 is a UML-type sequence diagram depicting (according to an example embodiment of the present invention) actions/steps in a method of facilitating charitable giving to a charity.

For simplicity (e.g., vis-à-vis FIGS. 4-6), FIG. 7 depicts interactive cookbook 400 as including interactive cookbook 700 and a DB (again, database) 702. In other words, cookbook 400 sans DB 702 corresponds to cookbook 700. DB 702 can include at least DB 106 and/or 108.

At arrow 710 in FIG. 7, cookbook 700 receives a first data file including data indicative of charitable payments received/processed by banking institution 114 on behalf of charitable entity 102. Regarding the donations/payments, the first file can include (respectively): identifications of the donors; the amounts; the receipt dates; methods of payment; etc. At arrow 712, cookbook 700 accesses DB 702 for donor data. At arrow 714, cookbook 700 receives the donor data from DB 702.

At arrow 716, cookbook 700 compares the donor data against the first data file to determine a list of new donors. At arrow 718, cookbook 700 updates the donor data according to the first data file. At arrow 720, cookbook 700 stores the updated donor data into DB 702. At arrow 720, cookbook 700 queries DB 702 for data regarding overdue acknowledgements (“ACKs”). At arrow 724, cookbook 700 receives the overdue ACK data. At arrow 726, cookbook 700 appends overdue ACKs to the gift ACK list.

At arrow 728, prompts user 402 to indicate whether he wishes to review one or both of the gift ACK list and the NEW donor list. At arrow 730, cookbook 400 receives from user 402 data indicative of the answer to the query of arrow 728.

The gift ACK list and the NEW donor list can be manipulated, e.g., sorted, according to one or more criteria. Such criteria can include: the amount of the payment; the date the payment was received; a classification of the donor; etc. For the NEW donor list, the classifications of donors may return NULL values such that the NEW donor list would not be sorted according to this criterion. For the gift ACK list, addition criteria can include: a status in which a special-attention flag, e.g., an alert-upon-donation flag, is true for the donor; a status in which an expiation flag is true for the donor; a value of an expiation parameter associated with the donor; etc.

A special-attention flag could be used, e.g., in association with a donor which charitable entity 102 has determined should receive special attention, e.g., as a phone call acknowledging a donation as well as written acknowledgement. An expiation flag can be used, e.g., in association with a donor to which charitable entity 102 has determined to make amends or atone, e.g., for a past clerical mistake or oversight, etc.

At arrow 732, cookbook 700 automatically provides user 402 with at least two candidate criteria from which to choose. At arrow 734, cookbook 400 receives from user 402 data indicative of one or more selected criteria. At arrow 736, cookbook 400 automatically prompts user 402 to rank the criteria if two or more criteria have been designated for the lists, respectively. Action 736 is conditional upon at least two criteria being designated for at least one of the lists, which is indicated by the square brackets in the label, namely “[multiple]”. At arrow 738, cookbook 400 receives from user 402 data indicative of how the criteria for the lists are to be ranked, respectively. Action 738 is conditional upon user 402 being prompted at action 732, which is indicated by the square brackets in the label, namely “[736]”.

At arrow 740, cookbook 700 manipulates, e.g., sorts, the gift ACK list and the NEW donor list according to the selected (and possibly ranked) criteria, respectively. Action 740 is conditional upon there being criteria selected for the lists, respectively, which is indicated by the square brackets in the label, namely “[respective criteria]”. At arrow 742, cookbook 700 stores the lists (possibly sorted lists) into DB 702.

At arrow 744, cookbook 700 provides, e.g., displays, the gift ACK list to donor 402 if appropriate. Action 744 is conditional upon user 402 having indicated a desire to review the gift ACK list, which is indicated by the square brackets in the label, namely “[apropos]”.

At arrow 746, cookbook 700 provides, e.g., displays, the NEW donor list to donor 402 if appropriate. Action 746 is conditional upon user 402 having indicated a desire to review the NEW donor list, which is indicated by the square brackets in the label, namely “[apropos]”.

The various methodologies described above can be implemented in hardware and/or software. The hardware/software implementation may include a combination of processors, application service providers, application specific integrated circuits (ASICs) and/or articles of manufacture. An article of manufacture, e.g., a machine-readable medium, can include code portions (machine-executable instructions) embodied thereon that, when read and executed by a machine (e.g., a processor), cause the machine to perform the respective methodologies.

With some embodiments of the present invention having thus been described, it will be obvious that the same may be varied in many ways. Such variations are not to be regarded as a departure from the spirit and scope of the present invention, and all such modifications are intended to be included within the scope of the present invention.

1. A machine-readable medium comprising machine-executable instructions for performing a method, execution of which by a machine provides an interface representing a cookbook for facilitating charitable giving to a charity, the method including:
providing at least one of first, second and third recipes for accomplishing (1) a first mission of making at least one of a postal-based, an email-based and a telephone-based appeal for donations, respectively, (2) a second mission of dealing with donations received, and (3) a third mission of acknowledging receipt of donations, respectively,
each recipe including names of tasks, performance of which cumulatively accomplishes the corresponding mission, and
a given recipe being provided without also providing application software by which to carry out the respective tasks; and
automatically generating an interface by which an agent of the charity can at least view the respective recipes.

2. The machine-readable medium of claim 1, wherein the machine-executed method further includes, for at least a given one of the recipes, at least the following:
treating the given recipe as a set and at least the task-names in the given recipe as members of the set;
arranging the members of the given recipe into a sequence for which each member has an index value;
automatically initializing a value of a variable, i;
automatically selecting a member having an index value equal to i, TASK(i), from the sequence;
automatically prompting, via the interface, for TASK(i) to be executed;
awaiting receipt of data indicative of completion of TASK(i);
automatically incrementing, upon receipt of the completion-indicative information, the index such that i=i+1; and
automatically looping back to the step of automatically selecting.

3. The machine-readable medium of claim 2, wherein the awaiting step includes:
receiving the completion-indicative data from at least one of the following,
the charity, and
a service provider with whom the charity has an arrangement to service TASK(i).

4. The machine-readable medium of claim 2, wherein the machine-executed method further includes:
providing at least the following candidate arrangements of the sequence,
a first arrangement that orders the tasks as a single path of serial execution, with tasks that otherwise could be performed in parallel being ordered according to a degree of difficulty,
a second arrangement that represents a hybrid serial/parallel organization, where at least some of the sequence is a single path of serial execution and at least some of the sequence is represented by parallel paths of serial execution, with tasks that otherwise could be performed in parallel being ordered according to a degree of difficulty;
automatically prompting, via the interface, for a selection to be made from among the candidate arrangements; and
receiving data indicative of the selection;
wherein the step of arranging is based upon the selected candidate arrangement.

5. The machine-readable medium of claim 4, wherein the machine-executed method further includes:
ordering, for the second arrangement, tasks that otherwise could be performed in parallel according to a degree of difficulty.

6. The machine-readable medium of claim 2, wherein the machine-executed method further includes:
automatically tracking an amount of time that elapses during the step of awaiting receipt of the data indicative of completion of TASK(i);
automatically comparing the elapsed time against a reference value; and
automatically generating a warning when the elapsed time exceeds the reference value.

7. The machine-readable medium of claim 6, wherein the machine-executed method further includes:
providing a plurality of reference values;
automatically prompting, via the interface, for a selection to be made from the plurality of reference values; and
receiving data indicative of the selection;
wherein the step of automatically comparing is based upon the selection.

8. The machine-readable medium of claim 1, wherein:
the interface is a interactive graphical user interface (GUI) of the type driven by pointing-device-events.

9. The machine-readable medium of claim 1, wherein the machine-executed method further includes:
providing a help database, with regard to at least some of the task-names, with information explaining, for a given task-name, at least one of what the corresponding task is and a suggestion as to how the corresponding task can be performed.

10. The machine-readable medium of claim 9, wherein:
the help database includes contact information for one or more service provider candidates appropriate to the corresponding task.

11. The machine-readable medium of claim 10, wherein the step of providing a help database includes:
automatically prompting, via the interface, for a selection between prospective help information that is charity-location-centric or not;
receiving data indicative of the selection; and
populating, according to the selection, the help database with service provider candidate information that is at least one of the following,
selected without regard to a geographical location of the charity, and
selected according to the geographical location of the charity.

12. The machine-readable medium of claim 11, wherein, for the given task-name, the step of populating with geographical-location-selected candidate information includes:
automatically prompting, via the interface, for a geographical location to be designated;
receiving data indicative of a geographical location; and
automatically accessing information resources to identify relevant service providers within a reference distance from the geographical location;
automatically selecting candidates from among the relevant service providers; and
automatically retrieving information about the candidates; and
automatically populating the help database with the retrieved information.

13. The machine-readable medium of claim 12, wherein, for the given task-name, when geographical-location-selected candidate information is used, the step of populating includes:
automatically prompting, via the interface, for the reference distance to be designated; and
receiving data indicative of the reference distance;
wherein the step of automatically accessing information resources establishes the reference distance according to the received data indicative thereof.

14. The machine-readable medium of claim 11, wherein, for the given task-name, the step of automatically selecting candidates from among the relevant service providers includes:
at least one of filtering, sorting and prioritizing the relevant service providers according to one or more criteria.

15. The machine-readable medium of claim 14, wherein the one or more criteria include whether a given service provider has status as least one of the following:
a minority-owned business;
a charity;
a non-profit entity;
a not-for-profit entity; and
a faith-based organization.

16. The machine-readable medium of claim 14, wherein there are at least two candidate criteria and wherein, for the given task-name, the step of automatically selecting candidates from among the relevant service providers further includes:
automatically providing, via the interface, the at least two candidate criteria;
automatically prompting, via the interface, for one of the candidate criteria to be selected;
receiving first data indicative of the selected criterion;
automatically prompting, via the interface, for an indication of whether the selected criterion is to be used to filter, sort or prioritize; and
receiving second data indicative that the selected criterion is to be used to filter, sort or prioritize;
wherein the respective filtering, sorting and prioritizing is based upon the first and second data.

17. The machine-readable medium of claim 1, wherein tasks corresponding to task-names of the first recipe include:
defining as a first ingredient a charitable donation, in terms of characteristics thereof, that is being solicited; and
defining as a second ingredient a target group, in terms of characteristics thereof, to whom the solicitation is to be made.

18. The machine-readable medium of claim 17, wherein the tasks corresponding to task-names of the first recipe further include:
drafting a written statement, for which the intended reader is a member of the target group, describing that which is to be solicited; and
populating the target group with members.

19. The machine-readable medium of claim 18, wherein the tasks corresponding to task-names of the first recipe further include:
making a list of new members of the target group; and
vetting the list via an external resource.

20. A machine-readable medium comprising machine-executable instructions for performing a method, execution of which by a machine facilitates charitable giving to a charity, the method including:
providing a donor database;
receiving a first data file including data indicative of charitable payments received on behalf of the charity, the amounts thereof, and identifications of the payors thereof, respectively;
automatically updating the donor database according to the first data file; and
automatically generating, based upon the updated donor database, a second data file representing at least a list regarding donors to whom a gift acknowledgement should be communicated.

21. The machine-readable medium of claim 20, wherein the step of automatically generating the list includes:
automatically sorting the list according to according to one or more criteria.

22. The machine-readable medium of claim 21, wherein the one or more criteria include at least one of the following:
the amount of the payment;
the date the payment was received, wherein the first data file also includes dates that the payments were received, respectively;
a classification of the donor;
a status in which a special-attention flag is true for the donor;
a status in which an expiation flag is true for the donor; and
a value of an expiation parameter associated with the donor.

23. The machine-readable medium of claim 22, wherein there are at least two candidate criteria and wherein the step of automatically sorting further includes:
automatically providing, via the interface, the at least two candidate criteria;
automatically prompting, via the interface, for at least one of the candidate criteria to be selected;
receiving third data indicative of the at least one selected criterion; and
automatically sorting the list according to the third data.

24. The machine-readable medium of claim 23, wherein the step of automatically sorting further includes:
determining if the third data includes two or more selected criteria; and
doing, if so, at least the following,
automatically prompting, via the interface, for a ranking of the two or more selected criteria,
receiving fourth data indicative of the ranking, and
the step of automatically sorting doing so according to the third and fourth data.

25. The machine-readable medium of claim 20, wherein the step of automatically generating the gift acknowledgement list includes:
automatically querying the database for gift acknowledgements that are overdue; and
appending, based upon the results of the step of automatically querying, the second data file to expand the list to further include any donors for which a gift acknowledgement is overdue.

26. The machine-readable medium of claim 20, wherein the machine-executed method further includes:
automatically querying the database for matches between the identifications of the payors in the first data file and identifications of donors in the database; and
automatically generating a third data file representing at least a list of new donors not previously present in the database.

27. The machine-readable medium of claim 26, wherein the machine-executed method further includes:
automatically generating an interface by which an agent of the charity can at least view the list which the third data file represents.

28. The machine-readable medium of claim 20, wherein the machine-executed method further includes:
automatically querying the database for selected matches between the identifications of the payors in the first data file and identifications of donors in the database, the selected matches corresponding to matching donors having a status in which at least one of a Notify-Upon-Donation flag and an expiation flag is true; and
automatically generating a third data file representing a list of the selected matching donors.

29. The machine-readable medium of claim 28, wherein the machine-executed method further includes:
automatically generating an interface by which an agent of the charity can at least view the list which the third data file represents.

30. A method of providing an interface representing a cookbook for facilitating charitable giving to a charity, the method including:
providing at least one of first, second and third recipes for accomplishing (1) a first mission of making at least one of a postal-based, an email-based and a telephone-based appeal for donations, respectively, (2) a second mission of dealing with donations received, and (3) a third mission of acknowledging receipt of donations, respectively,
each recipe including names of tasks, performance of which cumulatively accomplishes the corresponding mission, and
a given recipe being provided without also providing application software by which to carry out the respective tasks; and
automatically generating an interface by which an agent of the charity can at least view the respective recipes.

31. A method for facilitating charitable giving to a charity, the method comprising:
providing a donor database;
receiving a first data file including data indicative of charitable payments received on behalf of the charity, the amounts thereof, and identifications of the payors thereof, respectively;
automatically updating the donor database according to the first data file; and
automatically generating, based upon the updated donor database, a second data file representing a list donors to whom a gift acknowledgement should be communicated.

32. An apparatus to provide an interface representing a cookbook for facilitating charitable giving to a charity, the apparatus comprising:
task means for providing at least one of first, second and third recipes for accomplishing (1) a first mission of making at least one of a postal-based, an email-based and a telephone-based appeal for donations, respectively, (2) a second mission of dealing with donations received, and (3) a third mission of acknowledging receipt of donations, respectively,
each recipe including names of tasks, performance of which cumulatively accomplishes the corresponding mission, and
a given recipe being provided without also providing application software by which to carry out the respective tasks; and
interface means, operatively coupled to the task means, for automatically generating an interface by which an agent of the charity can at least view the respective recipes.

33. An apparatus for facilitating charitable giving to a charity, the method comprising:
a donor database;
receiving means for receiving a first data file including data indicative of charitable payments received on behalf of the charity, the amounts thereof, and identifications of the payors thereof, respectively;
update means for automatically updating the donor database according to the first data file; and
generator means, responsive to the update means, for automatically generating, based upon the updated donor database, a second data file representing a list donors to whom a gift acknowledgement should be communicated.
